(19) United States
(12) Patent Application Publication
(10) Pub. No.: US 2018/0214896 A1
(43) Pub. Date: Aug. 2, 2018

(54) Head of a Spray Gun

(71) Applicant: Zhejiang Prulde Electric Appliance Co., Ltd., Jinhua City (CN)

(72) Inventors: Weiming Yang, Jinhua City (CN); Ting Han, Jinhua City (CN)

(21) Appl. No.: 15/524,542

(22) PCT Filed: Jun. 6, 2016
(86) PCT No.: PCT/CN2016/000292

§ 371 Date: May 4, 2017

(30) Foreign Application Priority Data
Apr. 19, 2016 (CN) 201620336015.X

(51) Int. Cl. B05B 7/12; B05B 12/00

(52) U.S. Cl. CPC B05B 7/12; B05B 12/002

(57) ABSTRACT

A head of a spray gun mounted on a core inside a spray gun, comprises a nozzle disposed at an end of the core; a sprayer covered at the front of the nozzle, the sprayer having a plurality of side air passing blocks; a rotatable air volume regulating sleeve disposed at the rear of the nozzle; a plurality of air regulating holes disposed on the rotatable air volume regulating sleeve; a sprayer nut for enclosing the nozzle, the sprayer, and the rotatable air volume regulating sleeve; wherein the nozzle has a plurality of side air passing holes, when the rotatable air volume regulating sleeve rotates, at least one air passing hole overlaps with at least one air regulating hole, overlapping between at least one air passing hole and at least one air regulating hole adjust an air volume passing through the head of a spray gun. The present invention can perform high-precision air volume regulation and is particularly suitable for high-precision spraying operations.

### RELATE APPLICATIONS

This application is a national phase entrance of and claims benefit to PCT Application for a probe for a head of a spray gun, PCT/CN2016/000292, filed on Jun. 6, 2016, which claims benefit to Chinese Patent Applications 201620336015.X, filed on Apr. 19, 2016. The specifications of both applications are incorporated here by this reference.

### TECHNICAL FIELD OF THE INVENTION

The present invention relates to a spray gun and in particular to a head of a spray gun.

### BACKGROUND OF THE INVENTION

The spray gun of the present invention refers to an electric tool used for spraying. As industries such as home decoration become sophisticated and refined, a good spray gun serves as the premise of the quality of construction. However, the spraying effect of a spray gun greatly depends upon the sprayer of the spray gun. High-grade sprayers can achieve various effects and schemes of spraying. For example, a U.S. Pat. No. 9,010,658B2 disclosed a reversible airless spray tip assembly. The tip assembly comprises, cap having first radial bore; rotatable cylinder disposed within first radial bore; spray tip, comprising tip, annular projection, and spray orifice; sleeve comprises second axial bore therethrough and is disposed upstream of first radial bore adjacent to spray tip; shutoff disposed upstream of rotatable cylinder within cap, comprising seat and ball; dead zone 116 disposed between spray tip and shutoff. The compressible materials can be eliminated when spray tip 114 is shut off.

The tip assembly 100 comprises cylinder 112, cylinder 112 further comprises spray tip 114 and is at one end of dead zone 116; shutoff 118 comprises seat 122 and ball 120. By mating the tip 114 and the seat assembly 118 into one, the seal 124 can be moved out of the dead zone 116 thus reducing spit volume and energy storage.

However, in the actual operation process, the function of such a tip is limited, and the further refinement of parameter adjustment can not be achieved. Operator is not very convenient to adjust the tip.

### SUMMARY OF THE INVENTION

A technical problem to be solved by the present invention is to provide, with regard to the technical problems in the prior art, a head of a spray gun to further refine functions of a sprayer, by which various different spraying effects can be achieved by simple adjustment by the operator with one hand. The head of a spray gun is particularly applicable for DIY operations of home users.

To solve the abovementioned technical problems, the head of a spray gun mounted on a core inside a spray gun, comprises a nozzle disposed at an end of the core, the nozzle having a front and a rear; a sprayer covered at the front of the nozzle, the sprayer having a front surface and a plurality of side air passing blocks on the front surface of the sprayer; a rotatable air volume regulating sleeve disposed at the rear of the nozzle, the rotatable air volume regulating sleeve having a front; a sprayer nut for enclosing the nozzle, the sprayer, and the rotatable air volume regulating sleeve; wherein the rotatable air volume regulating sleeve has a flange at the front of the rotatable air volume regulating sleeve, the flange has a front surface, the front surface of the flange abuts the nozzle, and the front surface of the flange has a plurality of air regulating holes; the nozzle has a plurality of side air passing holes, when the rotatable air volume regulating sleeve rotates, at least one side air passing hole overlaps with at least one air regulating hole, overlapping between at least one side air passing hole and at least one air regulating hole adjust an air volume passing through the head of a spray gun. Under the coordination of the side air passing holes on the nozzle with the air regulating holes on the rotatable air volume regulating sleeve, the volume of air discharged from the side air passing blocks is changed so that the width in a horizontal, vertical, flat or square direction is regulated.

Preferably, a pushing button is disposed on a side surface of the rotatable air volume regulating sleeve, for rotating the rotatable air volume regulating sleeve. Such a structure can not only push the rotatable air volume regulating sleeve in a more labor-saving manner, and also play a role of indicating the rotating position.

Preferably, the nozzle has an edge and a positioning wall with at least two stopping steps is extending forward from the edge of the nozzle; the sprayer has a periphery surface and at least one protrusion is disposed on the periphery surface, the sprayer rotates to convert a spray direction between transversal and vertical; the at least one protrusion is positioned between two corresponding stopping steps of the positioning wall so as to make the sprayer to be positioned relative to the nozzle. Fast positioning can be achieved through the coordination thereof to adjust the final spraying effect. It is particularly convenient when a rectangular pattern is sprayed.

Preferably, the sprayer has a pressure relief hole, the nozzle has at least one pressure relief air inlet, the at least one pressure relief air inlet and the pressure relief hole can be aligned with each other. This structure allows air volume reduced on the side air passing blocks to be discharged from this hole, so that the service life of a motor is prolonged. Specifically, the pressure relief air inlet and the pressure relief hole always correspond to each other. However, the rear part of the pressure relief air inlet is used in coordination with the air regulating holes on the rotatable air volume regulating sleeve. When a large volume of air is required, the air regulating holes on the rotatable air volume regulating sleeve corresponds to the side air passing holes. However, when the volume of air discharged from the side air passing blocks is to be reduced, the rotatable air volume regulating sleeve is rotated, so that only a part of the air regulating holes corresponds to the side air passing holes and the other part thereof corresponds to the pressure relief air inlet. In this way, part of the airflow is discharged from the pressure relief hole to ensure that the volume of air discharged from the side air passing blocks is reduced.

Preferably, there are multiple side air passing holes on the nozzle, the number of pressure relief air inlet is the same as the side air passing holes, and each side air passing hole and each pressure relief air inlet are interlaced arranged. In this way, not only the space on the nozzle is effectively used, but also the mistaken coordination is avoided.

Preferably, the head of a spray gun further comprises a spray-direction converting cover, wherein the sprayer nut has a front and the spray-direction converting cover is disposed at the front of the sprayer nut; a plurality of pair of bumps are protruding from an inner wall the spray-direction converting cover; each side air passing block of the sprayer is positioned between one pair of bumps on the spray-direction converting cover, so that the spray-direction converting cover can rotate the sprayer. Such a structure can also ensure that, when the spray-direction converting cover is rotated, the spraying direction of the sprayer can rotate together with it.

Preferably, a process hole is provided on the spray-direction converting cover. Such a structure not only saves material and also facilitates de-molding during the manufacturing process.

Preferably, multiple anti-skid slots are provided on the periphery surface of the sprayer nut. In this way, it is convenient to tighten the sprayer nut.

Compared with the prior art, the head of a spray gun of the present invention can perform, with the structure thereof, high-precision air volume regulation by rotating the rotatable air volume regulating sleeve; meanwhile, the sprayer can be driven to rotate by adjusting the rotation of the spray-direction converting cover to achieve change in and adjustment to the spraying modes. The head of a spray gun of the present invention is particularly suitable for high-precision spraying operations. In addition, during the spraying process, no negative influence will be brought to a motor, and all the operations can be performed with one hand during the spraying process.

### BRIEF DESCRIPTION OF THE DRAWINGS

FIG. 1 is an exploded view of a head of a spray gun according to an embodiment of the present invention;

FIG. 2 is a perspective view of a nozzle of the head of a spray gun according to the embodiments of the present invention;

FIG. 3 is a perspective view of a sprayer of the head of a spray gun according to the embodiments of the present invention;

FIG. 4 is a sectional view of the head of a spray gun according to the embodiments of the present invention;

FIG. 5 is a perspective view of the head of a spray gun according to the embodiments of the present invention; and

FIG. 6 is another perspective view of the head of a spray gun according to the embodiments of the present invention, when it is mounted on a spray gun.

### DETAILED DESCRIPTION OF THE INVENTION

To enable a further understanding of the present invention content of the invention herein, refer to the detailed description of the invention and the accompanying drawings below:

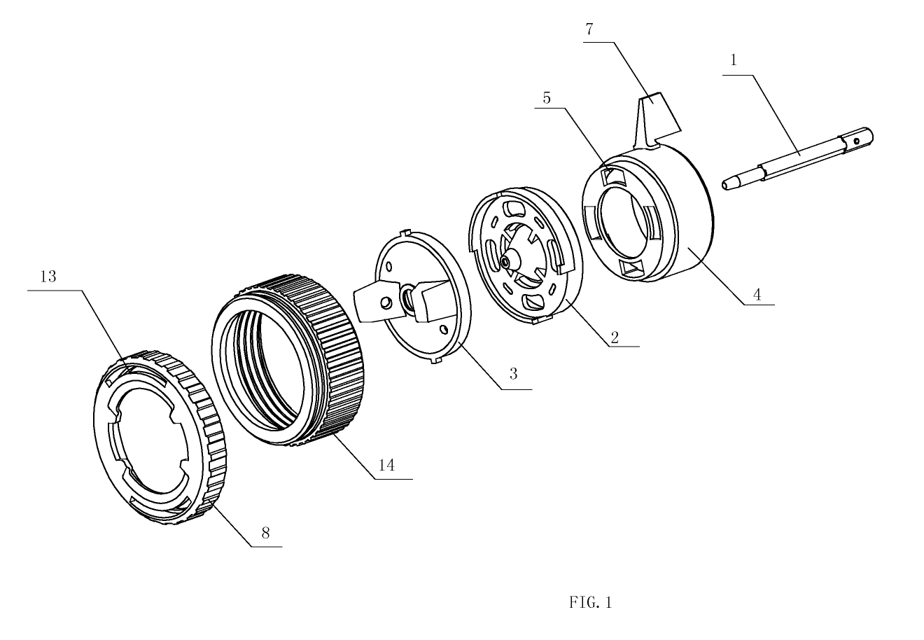

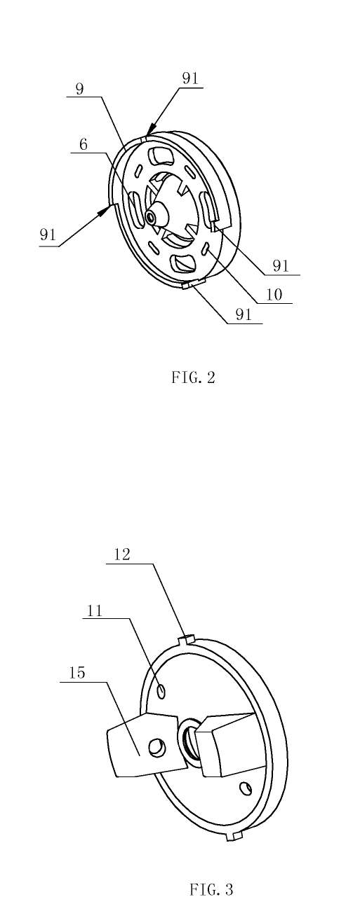

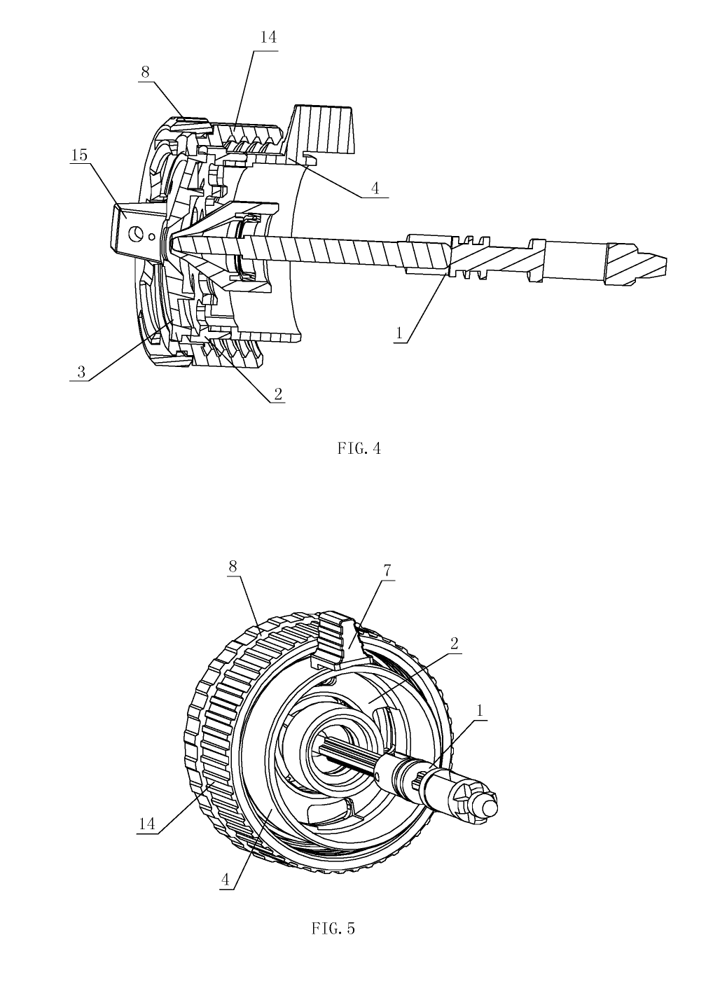

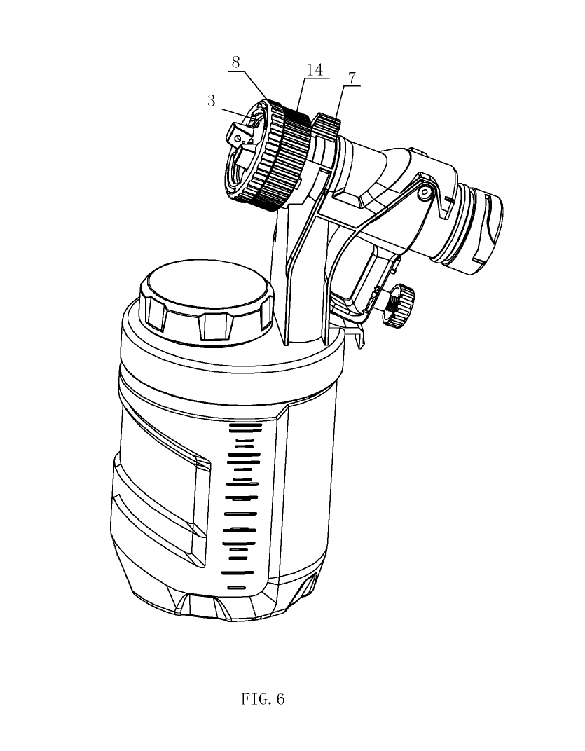

FIG. 1 to FIG. 5 show a head of a spray gun according to an embodiment the present invention. The head of a spray gun is mounted on a core 1 inside a spray gun body; the head of a spray gun comprises a nozzle 2 disposed at an end of the core 1, the nozzle having a front and a rear; a sprayer 3 covered at the front of the nozzle 2, the sprayer 3 is located at a front side in the axial direction of the nozzle 2 and this side is a side opposite to the core 1, the sprayer 3 having a front surface and a plurality of side air passing blocks 15 on the front surface of the sprayer 3. The nozzle has an edge and a positioning wall 9 with at least two stopping steps 91 is extending forward from the edge of the nozzle 2; a flat-cross reversal limiting bar 12 is provided on a side surface of the sprayer 3; the sprayer 3 has a periphery surface and at least one protrusion 12 is disposed on the periphery surface, the sprayer 3 rotates to convert a spray direction between transversal and vertical; the at least one protrusion 12 is positioned between two corresponding stopping steps 91 of the positioning wall 9 so as to make the sprayer 3 to be positioned relative to the nozzle 2. The sprayer 3 has a pressure relief hole 11, the nozzle 2 has at least one pressure relief air inlet 10, the at least one pressure relief air inlet 10 and the pressure relief hole 11 can be aligned with each other.

A rotatable air volume regulating sleeve 4 is disposed at the rear in the axial direction of the nozzle 2, i.e. at the same side as the core 1, the rotatable air volume regulating sleeve having a front; the rotatable air volume regulating sleeve 4 has a flange at the front of the rotatable air volume regulating sleeve 4, the flange has a front surface, the front surface of the flange abuts the nozzle 2, and the front surface of the flange has a plurality of air regulating holes 5 which are arranged in space in the circumferential direction. The nozzle 2 has a plurality of side air passing holes 6, when the rotatable air volume regulating sleeve 4 rotates, at least one side air passing hole overlaps with at least one air regulating hole 5, overlapping between at least one side air passing hole and at least one air regulating hole adjust an air volume passing through the head of a spray gun; each side air passing hole 6 and each pressure relief air inlet 10 are interlaced arranged. A pushing button 7 is disposed on a side surface of the rotatable air volume regulating sleeve 4, for rotating the rotatable air volume regulating sleeve 4, so that a relative angle between the air regulating holes 5 and the side air passing holes 6 on the nozzle 2 is adjusted, and the volume of air discharged from the side air passing holes 6 of the nozzle 2 is thus further adjusted. In this way, the volume of air discharged from the side air passing blocks 15 of the sprayer 3 is adjusted. The whole structure, including the nozzle 2, the sprayer 3 and the rotatable air volume regulating sleeve 4 mentioned above, is connected by a sprayer nut 14 arranged on their peripheries.

The head of the sprayer gun further comprises a spray-direction converting cover 8, wherein the sprayer nut 14 has a front and the spray-direction converting cover is disposed at the front of the sprayer nut 14; a plurality of pair of bumps are protruding from an inner wall the spray-direction converting cover 8; each side air passing block 15 of the sprayer 3 is positioned between one pair of bumps on the spray-direction converting cover 8, so that the spray-direction converting cover 8 can rotate the sprayer 3. A process hole 13 is provided on the spray-direction converting cover 8, while multiple anti-skid slots are provided on the periphery surface of the sprayer nut 14, and the at least one protrusion 12 is disposed on the sprayer 3, the sprayer 3 rotates to convert a spray direction between transversal and vertical. These structures bring convenience to the usage.

When in use, an operator adjusts the air regulating holes 5 on the rotatable air volume regulating sleeve 4 by stirring the pushing button 7, so that the volume of air discharged from the side air passing blocks 15 is adjusted, and the width in a horizontal, vertical, flat or square direction is thus regulated. All the operations can be performed directly with one hand during the spraying process and are thus very convenient.

1. A head of a spray gun mounted on a core inside a spray gun, comprising:
a nozzle disposed at an end of the core, the nozzle having a front and a rear;
a sprayer covered at the front of the nozzle, the sprayer having a front surface and a plurality of side air passing blocks on the front surface of the sprayer;
a rotatable air volume regulating sleeve disposed at the rear of the nozzle, the rotatable air volume regulating sleeve having a front;
a sprayer nut for enclosing the nozzle, the sprayer, and the rotatable air volume regulating sleeve;
wherein
the rotatable air volume regulating sleeve has a flange at the front of the rotatable air volume regulating sleeve, the flange has a front surface, the front surface of the flange abuts the nozzle, and the front surface of the flange has a plurality of air regulating holes;
the nozzle has a plurality of side air passing holes, when the rotatable air volume regulating sleeve rotates, at least one air passing hole overlaps with at least one air regulating hole, overlapping between at least one air passing hole and at least one air regulating hole adjust an air volume passing through the head of a spray gun.

2. The head of a spray gun of claim 1, wherein a pushing button is disposed on a side surface of the rotatable air volume regulating sleeve, for rotating the rotatable air volume regulating sleeve.

3. The head of a spray gun of claim 1, wherein the nozzle has an edge and a positioning wall with at least two stopping steps is extending forward from the edge of the nozzle;
the sprayer has a periphery surface and at least one protrusion is disposed on the periphery surface, the sprayer rotates to convert a spray direction between transversal and vertical;
the at least one protrusion is positioned between two corresponding stopping steps of the positioning wall so as to make the sprayer to be positioned relative to the nozzle.

4. The head of a spray gun of claim 1, wherein the sprayer has a pressure relief hole, the nozzle has at least one pressure relief air inlet, the at least one pressure relief air inlet and the pressure relief hole can be aligned with each other.

5. The head of a spray gun of claim 4, wherein there are multiple side air passing holes on the nozzle, the number of pressure relief air inlet is the same as the side air passing holes, and each side air passing hole and each pressure relief air inlet are interlaced arranged.

6. The head of a spray gun of claim 4, further comprising a spray-direction converting cover, wherein the sprayer nut has a front and the spray-direction converting cover is disposed at the front of the sprayer nut;
a plurality of pair of bumps are protruding from an inner wall the spray-direction converting cover;
each side air passing block of the sprayer is positioned between one pair of bumps on the spray-direction converting cover, so that the spray-direction converting cover can rotate the sprayer.

7. The head of a spray gun of claim 1, wherein a process hole is provided on the spray-direction converting cover.

8. The head of a spray gun of claim 1, wherein multiple anti-skid slots are provided on the periphery surface of the sprayer nut.
